(19) United States
(12) Patent Application Publication
(10) Pub. No.: US 2021/0341795 A1
(43) Pub. Date: Nov. 4, 2021

(54) DISPLAY DEVICE AND DISPLAY METHOD OF DISPLAY DEVICE

(71) Applicants: BEIJING BOE OPTOELECTRONICS TECHNOLOGY CO., LTD., Beijing (CN); BOE TECHNOLOGY GROUP CO., LTD., Beijing (CN)

(72) Inventors: Xiurong WANG, Beijing (CN); Mengmeng WANG, Beijing (CN); Shuaishuai XU, Beijing (CN); Lingyun SHI, Beijing (CN); Guangquan WANG, Beijing (CN); Ming CHEN, Beijing (CN)

(73) Assignees: BEIJING BOE OPTOELECTRONICS TECHNOLOGY CO., LTD., Beijing (CN); BOE TECHNOLOGY GROUP CO., LTD., Beijing (CN)

(21) Appl. No.: 16/613,215

(22) PCT Filed: Apr. 26, 2019
(86) PCT No.: PCT/CN2019/084542

§ 371 Date: Nov. 13, 2019

(30) Foreign Application Priority Data
May 16, 2018 (CN) 201810468533.0

(51) Int. Cl. G02F 1/13357; G02F 1/1335; G09G 3/36

(52) U.S. Cl. CPC G02F 1/133615; G09G 3/3607; G02F 1/133531

(57) ABSTRACT

A display device and a display method for the display device are provided by the present disclosure. The display device includes an edge-lit backlight source, a black-and-white display panel and a display panel stacked in sequence. The display panel includes a plurality of display units, each display unit includes at least one pixel unit, the black-and-white display panel includes at least one pixel, and each pixel corresponds to the display unit in one-to-one correspondence, an orthographic projection of each pixel onto the display panel coincides with the corresponding display unit.

### CROSS-REFERENCE TO RELATED APPLICATION

This application claims a priority to Chinese Patent Application No. 201810468533.0 filed on May 16, 2018, the disclosure of which is incorporated in its entirety by reference herein.

### TECHNICAL FIELD

The present disclosure relates to the field of display technology, in particular to a display device and a display method of the display device.

### BACKGROUND

In order to reduce a screen-door effect of a virtual reality (VR) device, a resolution ratio of a display screen of the VR device is continuously increased, which brings about a requirement on a contrast ratio of the display screen of the VR device.

### SUMMARY

In one aspect, a display device is provided, including: an edge-lit backlight source, a black-and-white display panel and a display panel stacked in sequence. The display panel includes a plurality of display units, each of the plurality of display units includes at least one pixel unit, the black-and-white display panel includes at least one pixel, and the at least one pixel corresponds to the plurality of display units in one-to-one correspondence, an orthographic projection of each of the at least one pixel onto the display panel coincides with a corresponding display unit.

In some embodiments of the present disclosure, the display panel includes a first display region, and the black-and-white display panel includes a second display region; and an orthographic projection of the first display region onto the black-and-white display panel falls within the second display region.

In some embodiments of the present disclosure, the black-and-white display panel is spaced apart from the display panel by a predetermined distance.

In some embodiments of the present disclosure, the display panel is a color display panel, and each of the plurality of display units of the display panel includes s three sub-pixels of different colors.

In some embodiments of the present disclosure, the black-and-white display panel and the display panel are both liquid crystal display panels.

In some embodiments of the present disclosure, the display device further includes:

a first polarizer located on a light-entering side of the black-and-white display panel,

a second polarizer located on a light-outgoing side of the black-and-white display panel, in which a direction of a light-transmitting axis of the first polarizer is perpendicular to a direction of a light-transmitting axis of the second polarizer,

a third polarizer located on the light-entering side of the display panel, in which a direction of a light-transmitting axis of the third polarizer is the same as the direction of the light-transmitting axis of the second polarizer, and

a fourth polarizer located on the light-outgoing side of the display panel, in which the direction of the light-transmitting axis of the third polarizer is perpendicular to a direction of a light-transmitting axis of the fourth polarizer,

where the second polarizer is located between the black-and-white display panel and the third polarizer.

In some embodiments of the present disclosure, the display device further includes:

a first polarizer located on a light-entering side of the black-and-white display panel;

a second polarizer located on a light-entering side of the display panel, in which a direction of a light-transmitting axis of the first polarizer is perpendicular to a direction of a light-transmitting axis of the second polarizer; and

a third polarizer located on a light-outgoing side of the display panel, in which a direction of a light-transmitting axis of the third polarizer is perpendicular to the direction of the light-transmitting axis of the second polarizer.

In some embodiments of the present disclosure, the display device further includes: a driving circuit configured to drive the black-and-white display panel to perform displaying, where the driving circuit is configured to acquire a reference grayscale value of each display unit of the display panel, and determine a grayscale value of the pixel of the black-and-white display panel corresponding to each display unit according to the reference grayscale value.

In some embodiments of the present disclosure, the reference grayscale value is an average value of grayscale values of all sub-pixels included in each display unit or a maximum value of the grayscale values of all the sub-pixels included in each display unit.

In some embodiments of the present disclosure, the black-and-white display panel includes a plurality of pixels, the plurality of pixels is divided into a plurality of pixel groups, each of the plurality of pixel groups includes a plurality of pixels, and the driving circuit is configured to drive each of the plurality of pixel groups.

In some embodiments of the present disclosure, the display device further includes an air layer between the black-and-white display panel and the display panel.

In some embodiments of the present disclosure, the black-and-white display panel is an advanced super dimension switch ADS display panel or a twisted nematic TN type display panel.

In some embodiments of the present disclosure, the display device is a virtual reality VR device.

A display method of a display device, applied to the above display device, is further provided by some embodiments of the present disclosure. The display method includes: obtaining a reference grayscale value of each display unit of the display panel; and determining, according to the reference grayscale value, a grayscale value of the pixel of the black-and-white display panel corresponding to each display unit, and driving the black-and-white display panel to perform displaying according to the grayscale value.

In some embodiments of the present disclosure, the display method further includes: in the case that one of the plurality of display units of the display panel displays an intermediate grayscale, compensating the pixel unit of the display panel for a grayscale, where the display unit includes a plurality of sub-pixels of different colors.

### BRIEF DESCRIPTION OF THE DRAWINGS

FIG. 1A is a structural schematic view of a display device according to some embodiments of the present disclosure;

FIG. 1B is a structural schematic view of a display panel according to some embodiments of the present disclosure;

FIG. 1C is a structural schematic view of a black-and-white display panel according to some embodiments of the present disclosure;

FIG. 1D is a structural schematic view of a display device according to some embodiments of the present disclosure;

FIG. 2 is a structural schematic view of a black-and-white display panel according to some embodiments of the present disclosure;

FIG. 3 is a structural schematic view of a display panel according to some embodiments of the present disclosure;

FIG. 4 is a structural schematic view of a display device according to some embodiments of the present disclosure; and

FIG. 5 is a flowchart of a display method of a display device according to some embodiments of the present disclosure.

### DETAILED DESCRIPTION

In order to make the technical solutions of the embodiments of the present disclosure clearer, the following detailed description will be made with reference to the drawings and some embodiments.

An increase in a contrast ratio of the display screen of the VR device is limited by an alignment accuracy, and the contrast ratio of the display screen of the VR device in a related art is low.

If the display screen of the VR device uses a direct-lit backlight source, by controlling a brightness and a switch of a light-emitting diode in different regions of the direct-lit backlight source, the contrast ratio of the display screen of the VR device can be improved. However, a manufacturing process of the direct-lit backlight source is complicated and a power consumption is high, so that the direct-lit backlight source cannot be widely used in the VR devices.

A display device and a display method thereof are provided by some embodiments of the present disclosure, which can improve the contrast ratio of the display device.

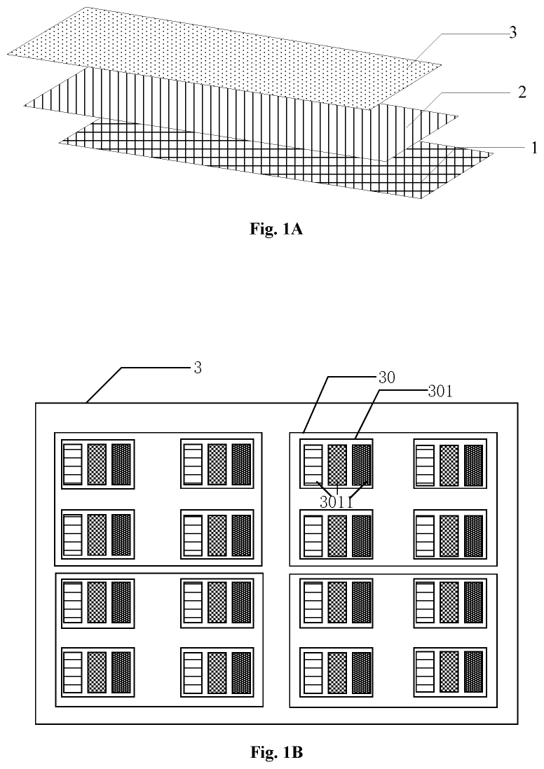

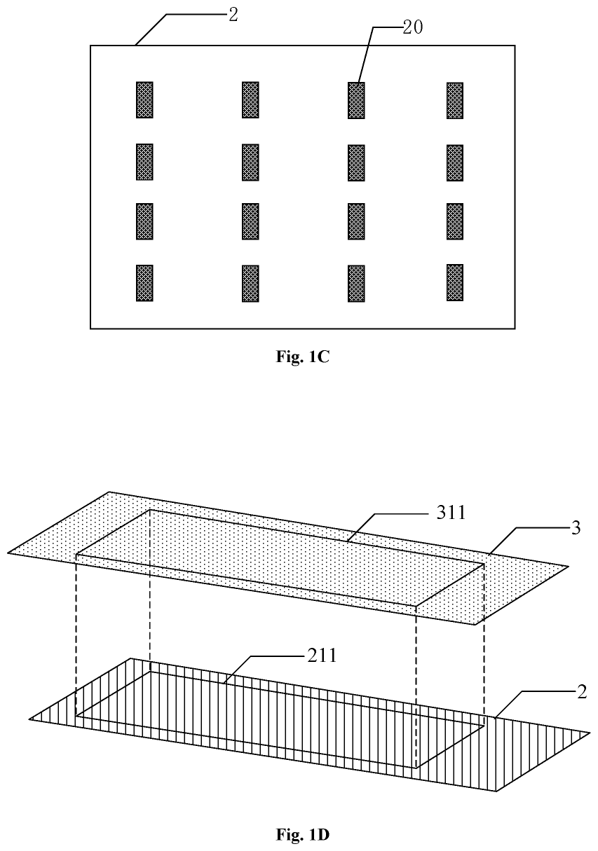

A display device is provided by some embodiments of the present disclosure. As shown in FIG. 1A, FIG. 1B and FIG. 1C, the display device includes an edge-lit backlight source 1, a black-and-white display panel 2, and a display panel 3, which are stacked in sequence.

The display panel 3 includes a plurality of display units 30, each display unit 30 includes at least one pixel unit 301, the black-and-white display panel 2 includes at least one pixel 20, and each pixel 20 corresponds to the display unit 30 in the display panel 3 in one-to-one correspondence, an orthographic projection of each pixel 20 of the black-and-white display panel 2 onto the display panel 3 coincides with the corresponding display unit 20.

In the present embodiment, the display device includes an edge-lit backlight source 1, a black-and-white display panel 2, and a display panel 3 which are stacked in sequence. The display panel 3 includes a plurality of display units 30, each display unit 30 includes at least one pixel unit 301. A pixel 20 of the black-and-white display panel 2 corresponds to the display unit 30 in the display panel 3 in one-to-one correspondence. Thus, in the case that the display panel 3 displays an image, a display grayscale of each pixel of the black-and-white display panel 2 can be controlled according to a display image of the display panel 3, thereby changing the contrast ratio of the display image of the display panel 3. In the case of using the edge-entering backlight source, the contrast ratio of the display device can be increased.

In some embodiments, the pixel in the black-and-white display panel includes one sub-pixel.

In some embodiments, the orthographic projection of each pixel 20 of the black-and-white display panel 2 onto the display panel 3 completely coincides with the corresponding display unit 30.

In some embodiments of the present disclosure, as shown in FIG. 1D, the display panel 3 includes a first display region 311, and the black-and-white display panel 2 includes a second display region 211; and an orthographic projection of the display region of the display panel 3 (the first display region 311) onto the black-and-white display panel 2 falls within the display region of the black-and-white display panel 2 (the second display region 211). An area of the display region of the black-and-white display panel 2 is the same as an area of the display region of the display panel 3 (as shown in FIG. 1D), or the area of the display region of the black-and-white display panel 2 is slightly larger than the area of the display region of the display panel 3, so that the contrast ratio of the display image of all the display region of the display panel 3 is enabled to be adjusted.

In some embodiments of the present disclosure, in order to prevent generation of moire pattern, a density of the pixels of the black-and-white display panel 2 is much lower than a density of the pixel units 301 of the display panel 3. Therefore, the pixels of the black-and-white display panel 2 correspond to at least one pixel unit 301 of the display panel 3.

In some embodiments of the present disclosure, in order to avoid the adverse influence of a trace, a thin film transistor and a pixel boundary of the black-and-white display panel 2 on the display panel 3, the black-and-white display panel 2 is spaced apart from the display panel 3 by a predetermined distance. The predetermined distance can be set as needed.

In some embodiments of the present disclosure, an air layer is arranged between the black-and-white display panel 2 and the display panel 3.

In some embodiments of the present disclosure, an optical film layer, such as a brightness enhancement film or a light-transmitting film, is arranged between the black-and-white display panel 2 and the display panel 3.

In some embodiments, as shown in FIG. 1B, the display panel 3 is a color display panel, and is enabled to display a color image. Each pixel unit 301 of the display panel 3 includes three sub-pixels 3011 of different colors. The sub-pixels 3011 of three different colors are, for example, red, green, and blue sub-pixels for color display.

In some embodiments of the present disclosure, the black-and-white display panel 2 and the display panel 3 are both liquid crystal display panels. The display device further includes:

a first polarizer located on a light-entering side of the black-and-white display panel 2,

a second polarizer located on a light-outgoing side of the black-and-white display panel 2, in which a direction of a light-transmitting axis of the first polarizer is perpendicular to a direction of a light-transmitting axis of the second polarizer,

a third polarizer located on the light-entering side of the display panel 3, in which a direction of a light-transmitting axis of the third polarizer is the same as the direction of the light-transmitting axis of the second polarizer, and

a fourth polarizer located on the light-outgoing side of the display panel 3, in which the direction of the light-transmitting axis of the third polarizer is perpendicular to a direction of a light-transmitting axis of the fourth polarizer;

the second polarizer is located between the black-and-white display panel and the third polarizer.

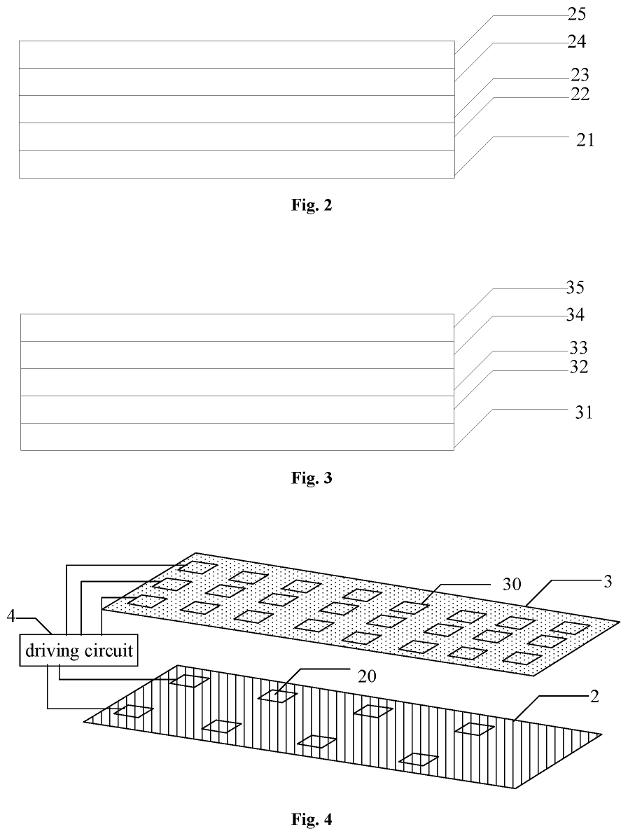

In some embodiments, as shown in FIG. 2, the black-and-white display panel 2 includes a first polarizer 21, an array substrate 22, a liquid crystal layer 23, a packaging cover 24 and a second polarizer 25 which are sequentially arranged. Directions of the light-transmitting axes of the first polarizer 21 and the second polarizer 25 are perpendicular to each other. As shown in FIG. 3, the display panel 3 includes a third polarizer 31, an array substrate 32, a liquid crystal layer 33, a color filter substrate 34 and a fourth polarizer 35. The light-transmitting axes of the third polarizer 31 and the fourth polarizer 35 are perpendicular to each other. Since the black-and-white display panel 2 is only used to adjust the contrast ratio of the display image of the display panel 3 and is not used for displaying the image, the black-and-white display panel 2 does not need to be provided with a color film.

In some embodiments, the packaging cover 24 adopts a glass substrate or a quartz substrate.

In some embodiments, the black-and-white display panel 2 is an advanced super dimension switch (ADS) display panel or a twisted nematic (TN) type display panel.

In the display device, the second polarizer 25 and the third polarizer 31 are located at a boundary between the display panel 3 and the black-and-white display panel 2, and directions of the light-transmitting axes of the second polarizer 25 and the third polarizer 31 are same.

In some embodiments, a side surface of the second polarizer 25 proximate to the third polarizer 31 and a side surface of the second polarizer 25 away from the third polarizer 31 both have stickiness. A side surface of the third polarizer 31 proximate to the second polarizer 25 and a side surface of the third polarizer 31 away from the second polarizer 25 both have stickiness.

Two opposite side surfaces of the second polarizer 25 and two opposite side surfaces of the third polarizer 31 are all have stickiness, so that the display panel 3 and the black-and-white display panel 2 are attached together.

In some embodiments, in order to reduce a thickness of the display device, only one polarizer may be arranged between the black-and-white display panel 2 and the display panel 3, that is, one of the second polarizer 25 and the first polarizer 31 may be omitted.

In some embodiments of the present disclosure, the black-and-white display panel 2 and the display panel 3 are both liquid crystal display panels. The display device further includes:

a first polarizer located on a light-entering side of the black-and-white display panel 2,

a second polarizer located on a light-entering side of the display panel 3, in which a direction of a light-transmitting axis of the first polarizer is perpendicular to a direction of a light-transmitting axis of the second polarizer, and

a third polarizer located on a light-outgoing side of the display panel 3, in which a direction of a light-transmitting axis of the third polarizer is perpendicular to the direction of the light-transmitting axis of the second polarizer.

In some embodiments of the present disclosure, as shown in FIG. 4, the display device further includes: a driving circuit 4 configured to drive the black-and-white display panel 2 to perform displaying. The driving circuit 4 is configured to acquire a reference grayscale value of each display unit of the display panel 3, and determine a grayscale value of the pixel of the black-and-white display panel 2 corresponding to the each display unit according to the reference grayscale value.

The pixels on the black-and-white display panel 2 are driven by the driving circuit 4, and a brightness value of a corresponding region may be controlled by controlling the grayscale values of respective pixel on the black-and-white display panel 2.

In some embodiments, the driving circuit is controlled in units of pixels of the black-and-white display panel 2.

In some embodiments, a plurality of pixels of the black-and-white display panel 2 are grouped into one group and controlled according to different regions.

The grayscales of the pixels on the black-and-white display panel 2 are adjusted in real time, in accordance with the reference grayscale values of the corresponding display units of display panel 3.

In some embodiments, the reference grayscale value is an average value of grayscale values of all sub-pixels included in the display unit or a maximum value of the grayscale values of all the sub-pixels included in the display unit.

The reference grayscale value is not limited to the average value of grayscale values of all the sub-pixels included in the display unit or the maximum value of the grayscale values of all the sub-pixels included in the display unit, and may also be other calculation results obtained according to the grayscale values of all the subpixels included in the display unit.

In the case that the display unit of the display panel 3 needs to display the image with a low grayscale, the grayscale value of the corresponding pixel of the black-and-white display panel 2 is also correspondingly decreased, so that the brightness of the image emitted by the display device is lower. In the case that the display unit of the display panel 3 needs to display the image with a high grayscale, the grayscale value of the corresponding pixel of the black-and-white display panel 2 is also correspondingly increased, so that the brightness of the image emitted by the display device is higher. Therefore, the contrast ratio of the display image of the display device can be increased.

In some embodiments, in order to ensure a final display effect, in the case that the display panel 3 displays an intermediate grayscale, a grayscale compensation is performed on the pixel unit of the display panel 3, so that the final displayed grayscale brightness is equivalent to the original grayscale brightness.

For example, the reference grayscale value of the display unit of the display panel 3 is L220, and the brightness of the corresponding original display image is 120 nit. Since a light-transmitting ratio of the black-and-white display panel 2 is not 100%, the brightness of the final image displayed by the display device is low, which cannot reach to 120 nit. In this case, it is necessary to increase the grayscale value displayed by the display unit of the display panel 3, for example, to increase to L230, so that the brightness of the final image displayed by the display unit is 120 nit.

Assuming that the brightness of the edge-lit backlight source is 10000 nit and the light-transmitting ratio of the display panel 3 is 1.5%, in the case that the display device includes only the display panel 3, the grayscale of the pixel unit of the display device is L255, and a brightness of emitted light is 150 nit; in the case that the grayscale of the pixel unit is L0, the brightness of the emitted light is 0.3 nit, and the contrast ratio of the display device is C/R=150/0.3=500. In the case that the display device includes only the black-and-white display panel 2, the light-transmitting ratio of the black-and-white display panel 2 is 80%; in the case that the grayscale of the pixel of the black-and-white display panel 2 is L255, the brightness of the emitted light is 8000 nit; in the case that the grayscale of the pixel of the black-and-white display panel 2 is LO, the brightness of the emitted light is 80 nit, and the contrast ratio of the black-and-white display panel 2 is 100.

In the case that the display device includes the black-and-white display panel 2 and the display panel 3 at the same time, the grayscale of the pixel of the display device is L255, and the brightness of the emitted light is 8000*1.5%=120 nit; in the case that the grayscale of the pixel of the display device is LO, the brightness of the emitted light is 80*0.3/10000=0.0024 nit, and the overall contrast ratio of the display device is 120/0.0024=50000. It can be seen that, according to the technical solution of the embodiments, the contrast ratio of the display device can be increased to 10 thousands level.

In some embodiments, the display device is a VR device.

Since the VR device has a relatively high requirement on contrast ratio, according to the technical solution of the present embodiment, the contrast ratio of the VR device can be increased and the requirement on contrast ratio of the VR device can be met.

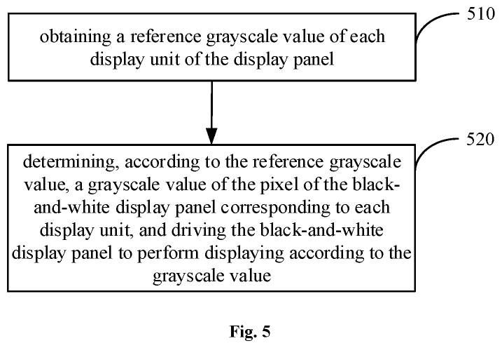

A display method of the display device, applied to the display device as described above, is provided by some embodiments of the present disclosure. As shown in FIG. 5, the display method includes step 510 and step 520.

Step 510: obtaining a reference grayscale value of each display unit of the display panel 3.

Step 520: determining, according to the reference grayscale value, a grayscale value of the pixel of the black-and-white display panel 2 corresponding to each display unit, and driving the black-and-white display panel 2 to perform displaying according to the grayscale value.

In the present embodiment, the display device includes an edge-lit backlight source 1, the black-and-white display panel 2 and the display panel 3 which are stacked in sequence. The display panel 3 includes the plurality of display units, each display unit includes at least one pixel unit 301. The pixel of the black-and-white display panel 2 corresponds to the display unit in the display panel 3 in one-to-one correspondence. Thus, in the case that the display panel 3 displays an image, the display grayscale of each pixel of the black-and-white display panel 2 can be controlled according to a display image of the display panel 3, thereby changing the contrast ratio of the display image of the display panel 3. In the case of using the edge-lit backlight source, the contrast ratio of the display device can be increased.

In some embodiments, the reference grayscale value of each display unit of the display panel 3 is obtained according to original data of an image to be displayed on the display panel 3. The reference grayscale value is the average value of grayscale values of all sub-pixels included in the display unit in the original data or the maximum value of the grayscale values of all the subpixels included in the display unit in the original data. The grayscale value of the corresponding pixel of the black-and-white display panel 2 may be determined according to the reference grayscale value. The black-and-white display panel 2 may be driven to perform displaying according to the determined grayscale value.

The reference grayscale value is not limited to the average value of grayscale values of all the sub-pixels included in the display unit or the maximum value of the grayscale values of all the sub-pixels included in the display unit, and may also be other calculation results obtained according to the grayscale values of all the subpixels included in the display unit.

In the case that the display unit of the display panel 3 needs to display the image with a low grayscale, the grayscale value of the corresponding pixel of the black-and-white display panel 2 is correspondingly decreased, so that the brightness of the image emitted by the display device is lower. In the case that the display unit of the display panel 3 needs to display the image with a high grayscale, the grayscale value of the corresponding pixel of the black-and-white display panel 2 is correspondingly increased, so that the brightness of the image emitted by the display device is higher. In such a manner, the contrast ratio of the display image of the display device can be increased.

In some embodiments, in order to ensure the final display effect, in the case that the pixel unit of the display panel 3 displays the intermediate grayscale, the grayscale compensation is performed on the pixel unit of the display panel 3, so that the final displayed grayscale brightness is equivalent to the original grayscale brightness.

For example, the reference grayscale value of the display unit of the display panel 3 is L220, and the brightness of the corresponding original display image is 120 nit. Since the light-transmitting ratio of the black-and-white display panel 2 is not 100%, the brightness of the final image displayed by the display device is low, which cannot reach to 120 nit. In this case, it is necessary to increase the display grayscale value of the display unit of the display panel 3, for example, to increase to L230, so that the brightness of the final image displayed by the display unit is 120 nit.

Assuming that the brightness of the edge-lit backlight source is 10000 nit and the light-transmitting ratio of the display panel 3 is 1.5%, in the case that the display device includes only the display panel 3, the grayscale of the pixel unit of the display device is L255, and the brightness of emitted light is 150 nit; in the case that the grayscale of the pixel unit is L0, the brightness of the emitted light is 0.3 nit, and the contrast ratio of the display device is C/R=150/0.3=500; thus, in the case that the display device includes only the black-and-white display panel 2, the light-transmitting ratio of the black-and-white display panel 2 is 80%; in the case that the grayscale of the pixel of the black-and-white display panel 2 is L255, the brightness of the emitted light is 8000 nit; in the case that the grayscale of the pixel of the black-and-white display panel 2 is LO, the brightness of the emitted light is 80 nit, and the contrast ratio of the black-and-white display panel 2 is 100. In the case that the display device includes the black-and-white display panel 2 and the display panel 3 at the same time, the grayscale of the pixel of the display device is L255, and the brightness of the emitted light is 8000*1.5%=120 nit; in the case that the grayscale of the pixel of the display device is LO, the brightness of the emitted light is 80*0.3/10000=0.0024 nit, and the overall contrast ratio of the display device is 120/0.0024=50000. It can be seen that, according to the technical solution of the present embodiments, the contrast ratio of the display device can be increased to 10 thousands level.

Unless otherwise defined, technical terms or scientific terms used in the present disclosure should be interpreted according to common meanings thereof as commonly understood by those of ordinary skills in the art. Such terms as “first”, “second” and the like used in the present disclosure do not represent any order, quantity or importance, but are merely used to distinguish different components. Such terms as “including”, or “comprising” and the like mean that an element or an article preceding the term contains elements or items and equivalents thereof behind the term, but does not exclude other elements or items. Such terms as “connect”, or “interconnected” and the like are not limited to physical or mechanical connections, but may include electrical connections, whether direct connection or indirect connection. Such terms as “on”, “under”, “left”, “right” and the like are only used to represent a relative position relationship, and when an absolute position of a described object is changed, the relative position relationship thereof may also be changed accordingly.

It may be understood that when an element such as a layer, a film, a region or a substrate is referred to as being “on” or “under” another element, the element may be “directly” “on” or “under” the another element, or there may exist an intervening element.

The above embodiments are merely optional embodiments of the present disclosure. It should be noted that numerous improvements and modifications may be made by those skilled in the art without departing from the principle of the present disclosure.

1. A display device, comprising:
an edge-lit backlight source, a black-and-white display panel and a display panel stacked in sequence; wherein
the display panel comprises a plurality of display units, each of the plurality of display units comprises at least one pixel unit, the black-and-white display panel comprises at least one pixel, and the at least one pixel corresponds to the plurality of display units in one-to-one correspondence, an orthographic projection of each of the at least one pixel onto the display panel coincides with a corresponding display unit.

2. The display device according to claim 1, wherein the display panel comprises a first display region, and the black-and-white display panel comprises a second display region; and
an orthographic projection of the first display region onto the black-and-white display panel falls within the second display region.

3. The display device according to claim 1, wherein the black-and-white display panel is spaced apart from the display panel by a predetermined distance.

4. The display device according to claim 1, wherein
the display panel is a color display panel, and each of the plurality of display units of the display panel comprises three sub-pixels of different colors.

5. The display device according to claim 1, wherein the black-and-white display panel and the display panel are both liquid crystal display panels.

6. The display device according to claim 5, further comprising:
a first polarizer located on a light-entering side of the black-and-white display panel;
a second polarizer located on a light-outgoing side of the black-and-white display panel, wherein a direction of a light-transmitting axis of the first polarizer is perpendicular to a direction of a light-transmitting axis of the second polarizer,
a third polarizer located on the light-entering side of the display panel, wherein a direction of a light-transmitting axis of the third polarizer is the same as the direction of the light-transmitting axis of the second polarizer; and
a fourth polarizer located on the light-outgoing side of the display panel, wherein the direction of the light-transmitting axis of the third polarizer is perpendicular to a direction of a light-transmitting axis of the fourth polarizer,
wherein the second polarizer is located between the black-and-white display panel and the third polarizer.

7. The display device according to claim 5, further comprising
a first polarizer located on a light-entering side of the black-and-white display panel;
a second polarizer located on a light-entering side of the display panel, wherein a direction of a light-transmitting axis of the first polarizer is perpendicular to a direction of a light-transmitting axis of the second polarizer; and
a third polarizer located on a light-outgoing side of the display panel, wherein a direction of a light-transmitting axis of the third polarizer is perpendicular to the direction of the light-transmitting axis of the second polarizer.

8. The display device according to claim 1, further comprising
a driving circuit configured to drive the black-and-white display panel to perform displaying, wherein the driving circuit is configured to acquire a reference grayscale value of each display unit of the display panel, and determine a grayscale value of the pixel of the black-and-white display panel corresponding to each display unit according to the reference grayscale value.

9. The display device according to claim 8, wherein the reference grayscale value is an average value of grayscale values of all sub-pixels comprised in each display unit or a maximum value of the grayscale values of all the sub-pixels comprised in each display unit.

10. The display device according to claim 8, wherein the black-and-white display panel comprises a plurality of pixels, the plurality of pixels is divided into a plurality of pixel groups, each of the plurality of pixel groups comprises a plurality of pixels, and the driving circuit is configured to drive each of the plurality of pixel groups.

11. The display device according to claim 3, further comprising an air layer between the black-and-white display panel and the display panel.

12. The display device according to claim 1, wherein the black-and-white display panel is an advanced super dimension switch ADS display panel or a twisted nematic TN type display panel.

13. The display device according to claim 1, wherein the display device is a virtual reality VR device.

14. A display method of a display device, applied to the display device according to claim 1, comprising:
obtaining a reference grayscale value of each display unit of the display panel; and
determining, according to the reference grayscale value, a grayscale value of the pixel of the black-and-white display panel corresponding to each display unit, and driving the black-and-white display panel to perform displaying according to the grayscale value.

15. The display method according to claim 14, further comprising:
in the case that one of the plurality of display units of the display panel displays an intermediate grayscale, compensating the pixel unit of the display panel for a grayscale, wherein the display unit comprises a plurality of sub-pixels of different colors.

16. The display device according to claim 2, wherein the display device is a virtual reality VR device.

17. The display device according to claim 3, wherein the display device is a virtual reality VR device.

18. The display device according to claim 4, wherein the display device is a virtual reality VR device.

19. The display device according to claim 5, wherein the display device is a virtual reality VR device.

20. The display device according to claim 6, wherein the display device is a virtual reality VR device.
